(19) United States
(12) Patent Application Publication
(10) Pub. No.: US 2006/0272162 A1
(43) Pub. Date: Dec. 7, 2006

(54) Food presentation system and assembly therefor

(76) Inventors: Andrea E. Atwater, Barrington, IL (US); Andrew J. Bartoli, Arlington Heights, IL (US)

Correspondence Address: ANDREA E. ATWATER, 114 RIVERWALK LANE, BARRINGTON, IL, 60010, US

(21) Appl. No.: 11/502,775

(22) Filed: Aug. 11, 2006

Related U.S. Application Data
(63) Continuation-in-part of application No. 10/459,821, filed on Jun. 11, 2003.

(51) Int. Cl. B26B 3/00

(52) U.S. Cl. 30/303

(57) ABSTRACT

A foldable blade assembly enables users to section and display a food preparation within a food preparation container. The blade assembly has an orthogonally configurable lattice of cutting blades sized and shaped to fit within a food preparation container for sectioning and displaying the food preparation. A plurality of hinge connections hingedly connect the cutting blades providing structure for pivotally changing the relationship between the cutting blades from the orthogonal arrangement to a substantially coplanar arrangement for storage. The end portions of the cutting blades are angled to compensate for angularity of the upright side of the food preparation container during use. At least one removable handle is provided to enable manual force perpendicular to the cutting blades for sectioning the food preparation.

### PRIOR HISTORY

This application is a continuation-in-part patent application claiming priority to pending U.S. patent application Ser. No. 10/459,821, filed in the United States Patent and Trademark Office on Jun. 11, 2003.

### BACKGROUND OF THE INVENTION

1. Field of the Invention

The claimed invention generally relates to an assembly for sectioning a food preparation. More specifically, the claimed invention relates to a blade assembly for enabling users thereof to section and display food preparations as form-prepared in food preparation containers and the like.

2. Description of the Prior Art

It is common practice to bake food items such as brownies, cakes, and cookies as one continuous sheet in food preparation containers of standard sizes such as 9 inches by 13 inches and 8 inches by 8 inches, or any number or circular food preparation containers having variously sized diameters. The baked or otherwise prepared food item is then commonly sliced into a plurality of smaller food items such as bars, squares, or wedge-shaped pieces for removal from the baking pan or food preparation container. The task of slicing the food preparation into bars, squares, or wedge-shaped pieces is commonly performed by using a knife or other similar instrument having a single cutting blade that is customarily used to make several individual longitudinal and lateral sectioning cuts defining the sides of each of the bars, squares, or wedge-shaped pieces.

The task of slicing the food preparation into a number of smaller food sections with a single bladed knife requires overcoming several challenges in order to achieve a desirable end result. One of the challenges that must be overcome is ensuring that the sectioning cuts are made straight. Freehandedly cutting a straight line in a sheet of brownies, for example, using a single bladed knife without reference to a straight edge such as the upright side of the food preparation container is often difficult to accomplish. Another challenge that must be overcome is ensuring that the sectioning cuts are made completely through the food item. If close attention is not paid to the depth of the cut made by the knife, the individual bars, squares, or wedge-shaped pieces will often not be completely separated. An even further challenge that must be overcome is ensuring that the food sections are sized appropriately. It is commonly desired to evenly section the food item so that all of the food sections are of the same size. However, it is difficult to achieve substantially equally sized and shaped food sections when freehandedly cutting the food preparation with a single blade knife.

There are several different types of cutting apparatuses in the prior art that use multiple cutting blades to cut food items into smaller sections. Some of these prior art devices are disclosed here in the form of previously issued United States Patents. However, these previously issued United States Patents do not disclose or teach a device that addresses the previously mentioned problems concerning cutting a sheet of brownies or similar type food item into a plurality of smaller portions within a baking pan having upright sides.

U.S. Pat. No. 1,175,512 ('512 Patent), which issued to Flemal, discloses a Scraper. The '512 Patent teaches a scraper comprising a plurality of assembling bars, a plurality of scraping blades arranged transversely of and interlocked with the assembling bars, a plate provided with depending flanges adapted to interlock with certain of the assembling bars, a hand grasp operatively connected to the plate, and clamping members coacting with the plate and certain of the assembling bars for maintaining the plate in applied position.

U.S. Pat. No. 1,754,541 ('541 Patent), which issued to Benoit, discloses an Egg Case Filler. The '541 Patent teaches a filler structure having cross walls. One of the cross walls is edge-notched to interlock with the other wall, which other wall comprises a D-slot through which the first wall is extended. The edges defining the D-slot present a bowed portion, the ends of which are shouldered and extended past a connecting straight portion to accommodate the notched wall when bowed without catching upon the notches in the edges thereof and to support the notched wall when straightened between the straight and shouldered portions which lie upon opposite sides of the wall.

U.S. Pat. No. 2,118,211 ('211 Patent), which issued to Lutz, discloses a Liquid Congealing Apparatus. The '211 Patent teaches a removable grid for dividing an ice tray into a plurality of cells for forming ice cubes comprising a single strip of flexible metal bent to form a plurality of vertical transverse walls of double thicknesses of metal, a plurality of vertical longitudinal walls formed of a single thickness of metal connecting adjacent thicknesses of the transverse walls, and a plurality of vertical longitudinal wall members extending between the transverse walls and each comprising two thicknesses of metal bent from the transverse walls and folded adjacent a contiguous transverse wall.

U.S. Pat. No. 4,000,845 ('845 Patent), which issued to Zeller, discloses a Partition Assembly and Partition Strips Therefor. The '845 Patent teaches a partition assembly having interlocking longitudinal and transverse partition strips to form compartments or cells for the reception of bottles, cans or other containers. The strips have sections that form the walls of the cells and are defined by spaced slots in each strip extending from one edge and a substantial depth into the strip and relatively shallow notches in the opposite edge of the strip in alignment with said slots. A set of sections, including the section at one end of each strip, has tabular projections near one edge extending into the slots in one direction, and a section at the opposite end of the strip has a tabular projection extending into a slot but in the opposite direction, the slots of the longitudinal strips interfitting with the slots of the transverse strips with the tabs of one interlocking in notches of the other forming a partition assembly.

U.S. Pat. No. 4,648,300 ('300 Patent), which issued to Hassenfelt, discloses a Biscuit Cutting Apparatus. The '300 Patent teaches a square frame surrounding and extending upwardly from a planar cutting surface to define a dough compartment. A plurality of vertical slots in each side wall extends from the top edge thereof down to the cutting surface to provide a guide for a cutting blade inserted therein. The slots are arranged in such a pattern that three, four, or six equal width slices may be formed in each direction depending on the slots selected for use. The cutter blade is accurately shaped along the bottom from end to end to ensure good contact with the cutting surface. An enlarged end portion at each end of the cutting blade prevents inadvertent dislodgement of the cutting blade during usage. A flour trough is provided on one side wall to facilitate the maintenance of a floured cutting blade during usage.

U.S. Pat. No. 5,074,777 ('777 Patent), which issued to Gamer, discloses an Apparatus for Making a Split Pie. The '777 Patent teaches a pie dividing assembly adapted to be inserted into a conventional circular pie pan once it is covered with a bottom sheet or layer of pie dough for separating the pie into a plurality of separate and distinct pie sections, preferably two, each adapted to receive a different and distinct pie filling therein before an optional top layer or cover of pie dough is placed thereover and the pie baked. Normally, after the pie is at least partially baked, approximately ⅔ baked, to where the pie filling has set, the pie divider is removed and the pie allowed to bake until done at which time the fully baked single unitary pie will have a plurality of sections each having a different and distinct pie filling therein. In the preferred embodiment of the present invention, the pie divider separates the pie into two equally dimensioned halves but embodiments are provided for separating the pie into three, four, six, eight, etc. dimensionally equal or unequal sections, as desired. The invention also contemplates a split-filling pie made as a product by process, and a method of making a split-filling pie. Another embodiment is provided for dividing a pizza into a plurality of different and distinct slices before the topping or combination of toppings is added.

U.S. Pat. No. 5,343,623 ('623 Patent), which issued to Cole, discloses a Knife Assembly for Cutting a Food Product. The '623 Patent teaches a knife blade and knife blade assembly for cutting food products into sticks or slices without causing surface cracking. The knife blade has a cutting portion defining a cutting edge and is mounted in the knife assembly such that a tension force is exerted on the knife blade in the plane of the cutting edge. The cutting edge of the knife blade is not sharp, but is generally flat and extends between parallel sides of the knife blade. The individual knife blades are formed of stainless steel and are electro-polished to remove any surface defects or sharp edges which may produce stress concentrations. This enables a significant tension force to be applied to the knife blade without diminishing its useful life. The electro-polishing process may also round off the corners of the juncture between the-flat cutting edge and the parallel knife blade sides.

U.S. Pat. No. 5,579,582 ('582 Patent), which issued to Carlson, discloses a Puzzle Cookie Cutter. The '582 Paten teaches a puzzle cookie cutter comprising a cutting die holder and at least one cutting die removably securable in the holder. The die or dies provide for the cutting of cookie dough, batter, or the like into several separate, irregularly shaped and sized interfitting pieces, which pieces may be reassembled as a puzzle after baking to provide entertainment for the consumer of the cookie. The dies may be provided in virtually any regular or irregular geometric shape, animal or other caricature or representation, and/or any alphanumeric character, as desired. The die or dies may also provide for the spaced apart separation of the cut dough or batter, to allow for expansion or flow of the batter or dough during the baking process, in order that the baked pieces will have a close fit with one another without interference. The cut pieces may be baked adjacent one another on a sheet or pan and decorated after the baking process as desired, then separated randomly to provide a challenge akin to that of the assembly of a relatively simple jigsaw or picture puzzle, in addition to the enjoyment of eating the baked cookie pieces.

U.S. Pat. No. 5,597,113 ('113 Patent), which issued to Bradford, discloses a Recyclable Container Partition. The '113 Paten teaches a collapsible partition assembly comprising a set of parallel longitudinal dividers and a set of parallel transverse dividers intersecting at a plurality of intersections. Each of the longitudinal dividers has a series of evenly spaced slots which extend downwardly from a top edge of the longitudinal divider to approximately the middle of the longitudinal divider. Each transverse divider has a series of evenly spaced slots, each slot extending upwardly from a bottom edge of the transverse divider to approximately the middle of the transverse divider. The slots of the longitudinal and transverse dividers engage with one another at the intersections. Dividers are secured to each other at each intersection by a securement bead which extends from a point proximate the top edge of the intersection to proximate the bottom edge of the intersection. The intersecting dividers create four angles. The securement bead runs along one angle and permits the partition assembly to be collapsed and recycled.

U.S. Pat. No. 5,848,470 ('470 Patent), which issued to Anderson, discloses an Impact Actuated Baker Grid Device. The '470 Patent teaches an impact actuated bakery grid device for producing uniform portions of baked goods wherein the grid device includes a force generating unit operatively associated with a handle member which is connected at widely spaced locations on a grid member for forcibly ejecting the portions of baked goods from within the confines of a plurality of compartments within the grid member.

U.S. Pat. No. 6,276,918 ('918 Patent), which issued to Slaughter et al., discloses a Dough Cutting Apparatus. The '918 Patent teaches a dough cutting apparatus comprising a plurality of spaced apart blades the lower edges of which are uniformly curved from one end of said blades to the other and a plurality of intersecting spaced apart blades the lower edges of which are straight. The blades cooperate to form multiple uniformly sized cavities therebetween. A handle is attached to the blades for engagement by the user of the apparatus for rocking the apparatus along the lower edges of the curved blades to separate a layer of dough into separate multiple dough products.

These previously issued United States Patents do not disclose or teach a food-cutting or sectioning device that is used to section a food item or preparation within a food preparation container into a plurality of uniformly sized and shaped smaller portions. Therefore, there is a need for a device that can uniformly and simultaneously section a food item or preparation within a container such as a food preparation container for displaying the food preparation in smaller portions. There is a further need for a device of this type that is easily stored during periods of time when the device is not in use. Therefore, there is a need for a blade assembly which is expandable for sectioning and displaying a food preparation in smaller food sections, and which assembly is collapsible into a folded form for ease of storage.

### SUMMARY OF THE INVENTION

To provide an answer for these needs, as well as other that will become apparent after reading this specification and viewing the appended drawings, the claimed invention provides a blade assembly usable in combination with a food preparation container to section and display a container-borne, form-prepared food preparation into a plurality of smaller food portions. It is an object of the claimed invention to provide a blade assembly capable of making straight sectioning cuts. It is a further object of the claimed invention to provide a blade assembly capable of making sectioning cuts of uniform depth. It is an even further object of the claimed invention to provide a blade assembly capable of sectioning an entire food item within a food preparation container into a plurality of uniformly shaped smaller sections. Still further, it is an object of the claimed invention to provide a blade assembly having a plurality of opposingly oriented blades that are collapsible into a compact configuration for storage.

To achieve these and other readily apparent objectives, the invention summarily comprises a foldable blade assembly for sectioning an entire food item, such as brownies, cakes, pies, cookies, lasagna, pizza, gelatin, etc. within a food preparation container or baking pan into a plurality of equally sized smaller sections. The blade assembly of the present invention generally comprises a plurality of lateral cutting blades, a plurality of longitudinal cutting blades, a plurality of hinges connecting the lateral and longitudinal blades, and at least one, but optionally, two handles.

The lateral cutting blades are sized and shaped to laterally section an entire food item width within a food preparation container or baking pan into a plurality of laterally sectioned smaller portions. Each of the lateral cutting blades has end portions angled to compensate for the angularity of upright walls of the food preparation container when the blade assembly is pressed into a food item within the food preparation container. The longitudinal cutting blades are sized and shaped to longitudinally section an entire food item length within a food preparation container into a plurality of longitudinally sectioned smaller portions. Each of the longitudinal cutting blades are hingedly attached to the lateral cutting blades thereby providing pivotal freedom of movement between the lateral cutting blades and the longitudinal cutting blades. Each longitudinal cutting blade has end portions angled to compensate for angularity of upright walls of the food preparation container when the blade assembly is pressed into a food item within the food preparation container.

Each handle is shaped for applying manual force perpendicular to the lateral cutting blades and longitudinal cutting blades during use. Each handle has a blade-receiving structure for receiving an upper edge of a select cutting blade. Each handle may thus be removably connected to the blades so that the blade assembly may be more easily folded into a closed position to reduce space required storage space of the blade assembly. The handles have a button that can be manually depressed to release the handles from the select cutting blades.

It is thought that the blade assembly may be configured for use in conjunction with a food preparation container which may have a size of 9 inches by 12 inches. However, the blade assembly of the claimed invention can be configured for use with food preparation containers of other sizes and shapes, such as 9 inches by 9 inches. During use, the lateral cutting blades and the longitudinal cutting blades coact to cut the food item within the pan into a plurality of smaller sections or bars.

### BRIEF DESCRIPTION OF THE DRAWINGS

Other features of our invention will become more evident from a consideration of the following brief description of patent drawings:

FIG. 1 is a perspective view of a first preferred embodiment of the blade assembly of the present invention sectioning and displaying a food preparation in a plurality of food sections borne by a food preparation container with one food section removed.

FIG. 2 is an exploded perspective view of the blade assembly, food preparation, and food preparation container shown in FIG. 1 showing the sectioned food sections with one food section removed.

FIG. 3 is a perspective view of the food preparation and food preparation container shown in FIG. 1 showing the sectioned food sections with one food section and the blade assembly removed.

FIG. 3(a) is a fragmentary side view depiction of a container bottom and container wall of the food preparation container.

FIG. 4 is a perspective view of the food preparation and blade assembly shown in FIG. 1 showing the sectioned food sections with one food section and the food preparation container removed.

FIG. 5 is a perspective view of an alternative blade assembly of the present invention.

FIG. 6 is a perspective view of a second preferred embodiment of the blade assembly of the present invention sectioning and displaying a food preparation in a plurality of food sections borne by a food preparation container with one food section removed.

FIG. 7 is an exploded perspective view of the blade assembly, food preparation, and food preparation container shown in FIG. 6 showing the sectioned food sections with one food section removed.

FIG. 8 is a perspective view of the food preparation and food preparation container shown in FIG. 6 showing the sectioned food sections with one food section and the blade assembly removed.

FIG. 9 is a first perspective type depiction of the blade assembly shown in FIG. 6 in a partially collapsed-expanded state.

FIG. 10 is a perspective view of the blade assembly shown in FIG. 6 in a fully expanded state.

FIG. 11 is a perspective view of a preferred food preparation container and preferred blade assembly of the present invention showing the food preparation removed.

FIG. 11(a) is an enlarged fragmentary exploded perspective type depiction of a hinge junction shown in FIG. 11.

FIG. 12 is a perspective type depiction of a preferred blade assembly of the present invention in a partially collapsed-expanded state.

FIG. 13 is a perspective type depiction of a preferred blade assembly of the present invention in a fully collapsed state with handle removed.

FIG. 14 is a top plan view depiction of a preferred blade assembly of the present invention.

FIG. 14(a) is a fragmentary enlarged end view type depiction of a junction intermediate a handle and blade of the blade assembly.

FIG. 15 is a fragmentary top perspective view of a food preparation and food preparation container showing the sectioned food sections with one food section and the blade assembly removed and depicting bulk food portions entering the food section vacancy.

FIG. 16 is a fragmentary top perspective view of a food preparation and food preparation container showing the sectioned food sections with one food section and the blade assembly removed and depicting bulk food portions smashed in the region where a blade junction otherwise operates to section the food preparation.

FIG. 17 is an enlarged fragmentary side view type depiction of a blade junction showing hinge structure with inferior pointed structure.

FIG. 18 is a perspective view of a blade assembly of the present invention positioned over a food preparation container bearing a food preparation with certain parts of the food preparation container broken away to show otherwise hidden food structure.

FIG. 18(a) is a fragmentary side view depiction of a food bottom and food wall of the food preparation.

FIG. 19 is a perspective view of an alternative blade assembly of the present invention positioned over a food preparation container bearing a food preparation.

FIG. 20 is a perspective view of the alternative blade assembly shown in FIG. 19 sectioning the food preparation into a plurality of smaller food sections with certain parts of the food preparation container broken away to show otherwise hidden food structure.

FIG. 21 is a top plan view of a blade assembly of the present invention sectioning and displaying a food preparation in a food preparation container.

FIG. 22 is a perspective view of an alternative embodiment of the blade assembly of the present invention.

FIG. 22(a) is a fragmentary side view depiction of a blade bottom and blade end of a lateral cutting blade.

FIG. 22(b) is a fragmentary side view depiction of a blade bottom and blade end of a longitudinal cutting blade.

FIG. 23 is a perspective view of an alternative embodiment of the blade assembly of the present invention.

FIG. 24(a) is an enlarged fragmentary depiction of a push-button assembly showing the assembly in a relaxed-spring, blade-retaining state.

FIG. 24(b) is an enlarged fragmentary depiction of a push-button assembly showing the assembly in an actuated-spring, blade-releasing state.

FIG. 25 is a cross-sectional side view depiction of a blade assembly comparatively depicting various heights of structures.

### DETAILED DESCRIPTION OF THE PREFERRED EMBODIMENT(S)

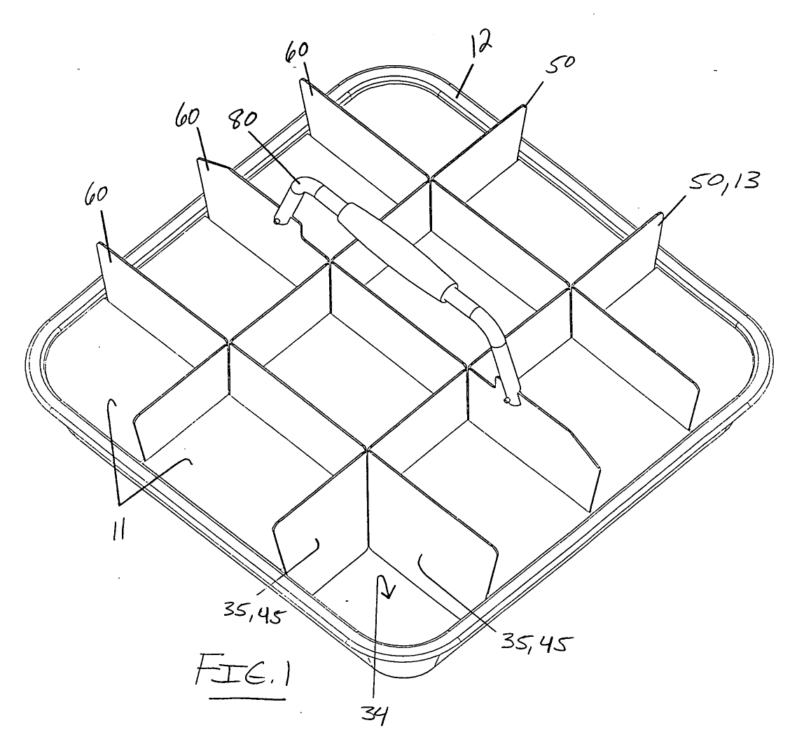

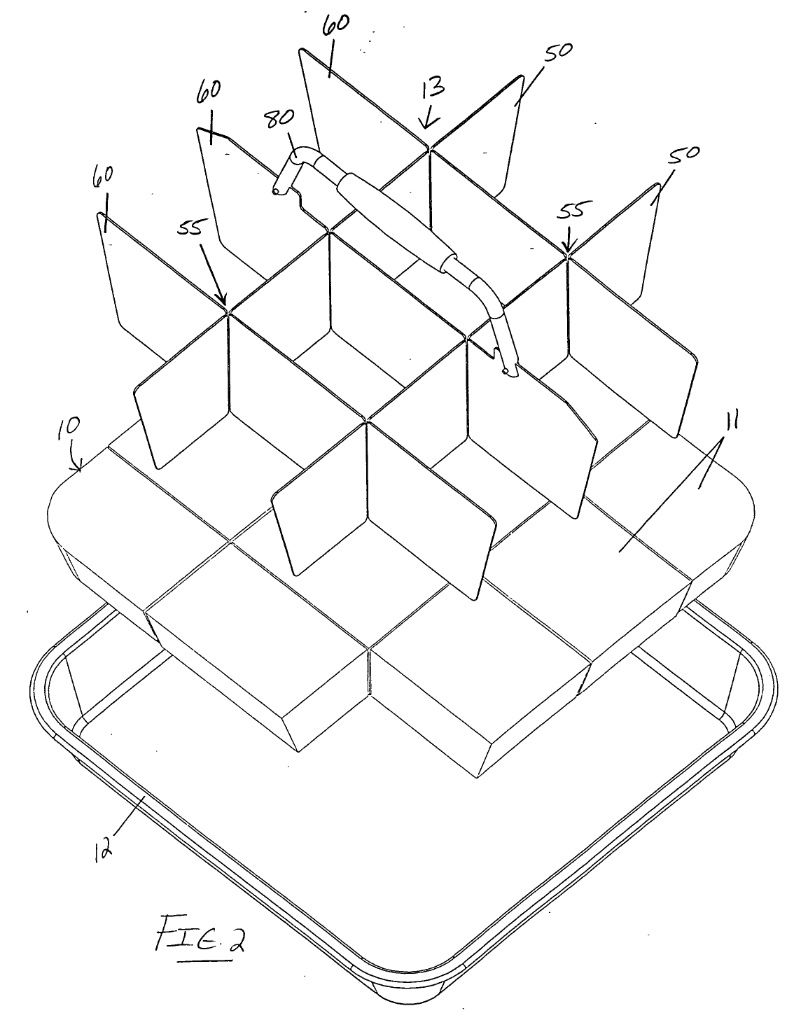

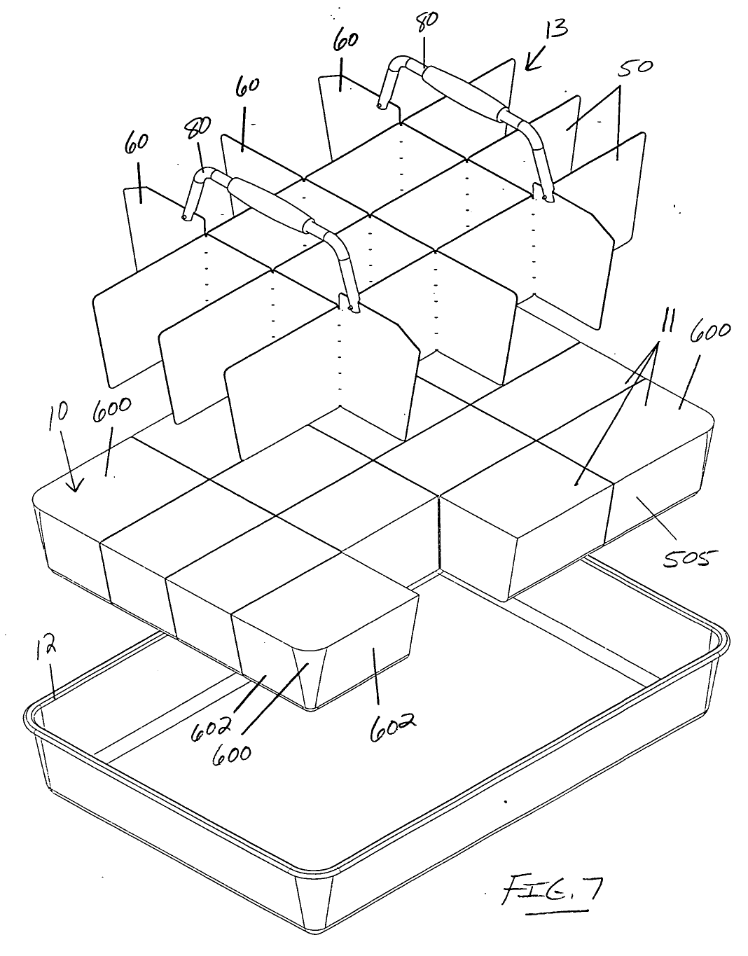

Referring now to the drawings, the preferred embodiment of the present invention generally concerns a food-presentation system for sectioning and displaying a container-prepared food preparation in(to) a plurality of food sections. The container-prepared food preparation 10 is generally depicted and referenced in FIGS. 2, 3, 7, 8, 15, 16, 18, 19, and 25; and the food sections 11 are generally depicted and referenced in FIGS. 1-4, 6-8, 15, 16, 20, and 21. It is contemplated that the food-presentation system of the present invention preferably comprises, in combination, a food preparation container 12 as illustrated and referenced in FIGS. 1-3, 6-8, 11, 15, 16, and 18-21; the container-prepared food preparation 10; and a blade assembly 13 as illustrated and referenced in FIGS. 1, 2, 4-7, 9-12, and 14.

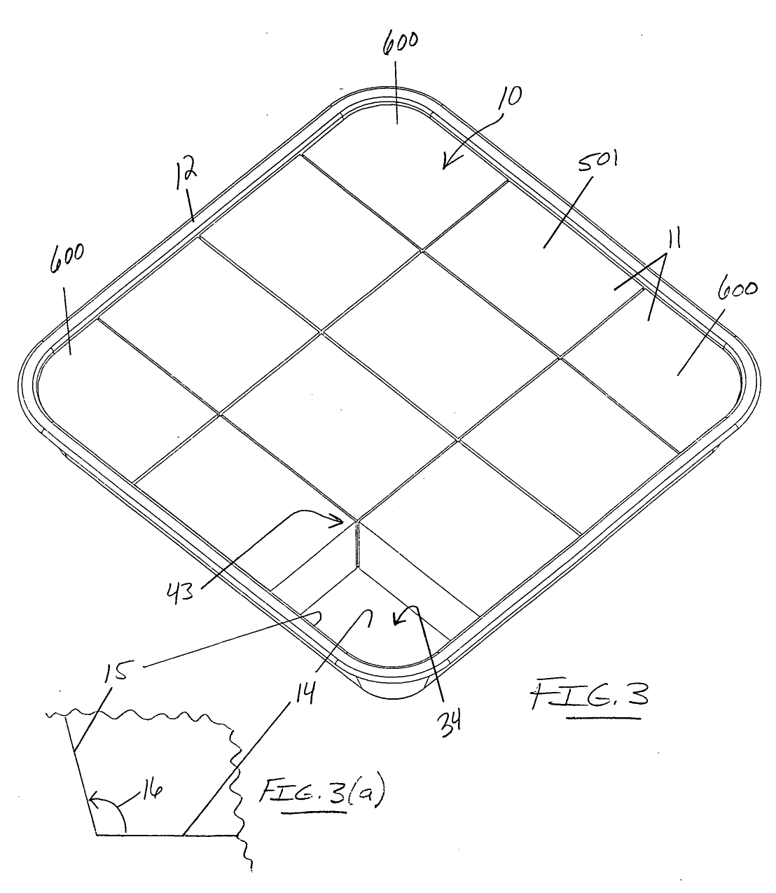

It will be seen from an inspection of the noted figures that the food preparation container 12 preferably comprises a rectangular, substantially planar container bottom 14 as depicted and referenced in FIGS. 3 and 3(a); and a peripheral container wall 15 as depicted and referenced in FIGS. 3, 3(a), and 18-20. The container wall 15 is preferably integrally formed to the container bottom 14 and extends upwardly and outwardly therefrom at a certain container angle of inclination 16, the container angle of inclination 16 preferably being greater than 90 degrees as generally depicted in FIG. 3(a). The container wall 15 preferably comprises first and second substantially planar latitudinal container portions 400 (one of which is referenced in FIGS. 18-20); and first and second substantially planar longitudinal container portions 401 (one of which is referenced in FIGS. 18-20). From an inspection of the noted figures, it will be seen that the latitudinal and longitudinal container portions 400 and 401 are joined at four container corners 402 (three of which are referenced in FIGS. (18-20).

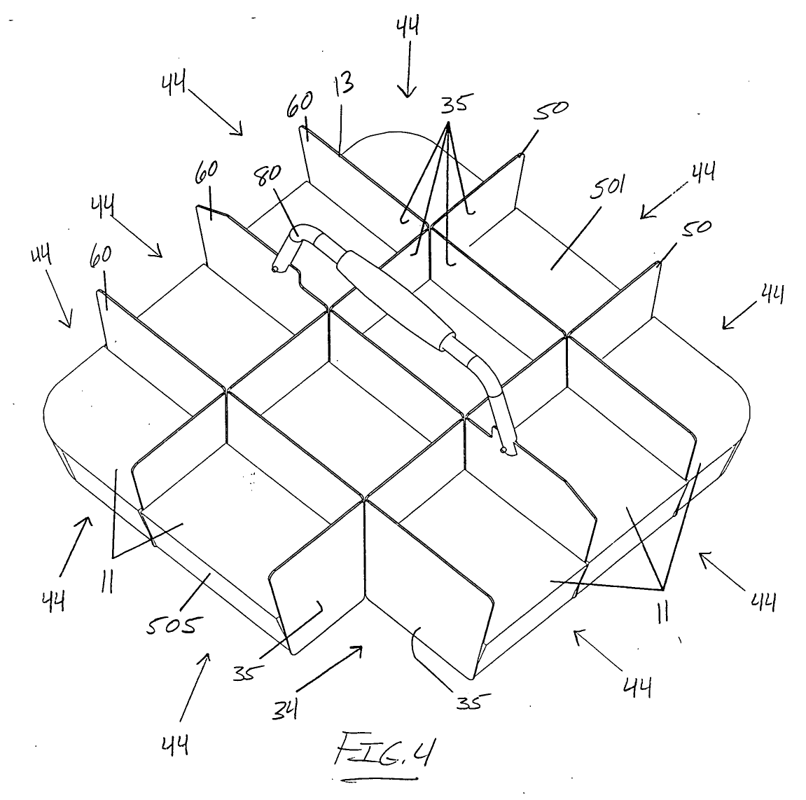

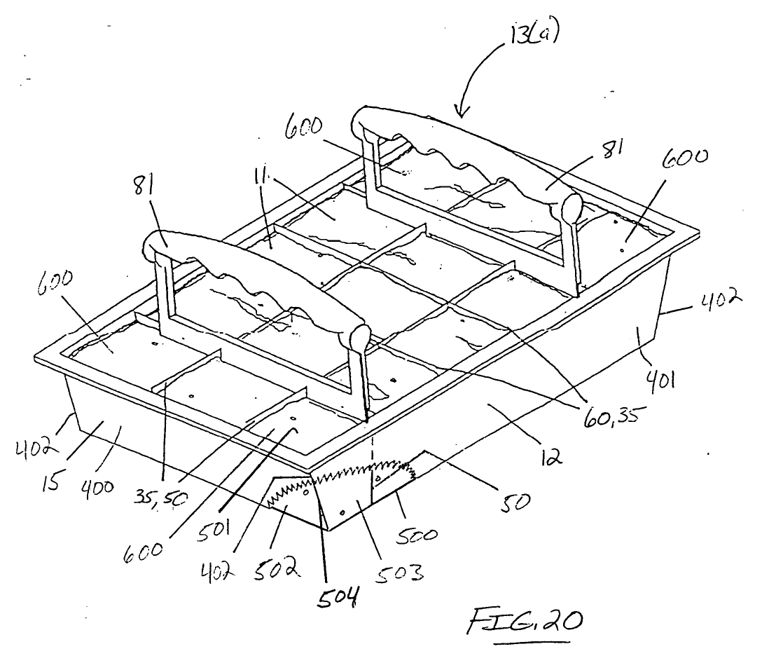

The food preparation 10 is essentially a (container) form-prepared food item and thus may be described as form-prepared in the food preparation container 12. The food preparation 10 thereby preferably comprises a substantially planar food bottom 500 as illustrated and referenced in FIGS. 18, 18(a), and 20; a peripheral food wall 505 as depicted and referenced in FIGS. 4, 7, 18, and 18(a); a superior food surface 501 as referenced in FIGS. 3, 4, 8, 15, 16, and 18-21; and a blade-sliceable bulk food portion, the bulk food portion being bound by the food bottom 500, food wall 505, and food surface 501. Notably, while preferably substantially planar, superior exposed food portions as form-prepared are not always planar. Food surface 501 may thus be somewhat irregular in form or non-planar. In any event, the bulk food portion has a maximal bulk thickness 100, which extends intermediate the food bottom 500 and food surface 501 as generally depicted in FIG. 25.

It should be readily understood that the food wall 505 preferably extends upwardly and outwardly from the food bottom 500 at a food angle of inclination 17, the food angle of inclination 17 preferably being equal in magnitude to the container angle of inclination 16 as generally and comparatively depicted in FIGS. 3(a) (showing container angle of inclination 16) versus 18(a) (showing food angle of inclination 17). The food wall 505 preferably comprises first and second substantially planar latitudinal food portions 502 (one of which is illustrated in FIGS. 18 and 20); and first and second substantially planar longitudinal food portions 503 (one of which is illustrated in FIGS. 18 and 20). From an inspection of the noted figures, it will be seen that the latitudinal and longitudinal food portions 502 and 503 are joined at four food corners 504 (one of which has been depicted and referenced in FIGS. 18 and 20).

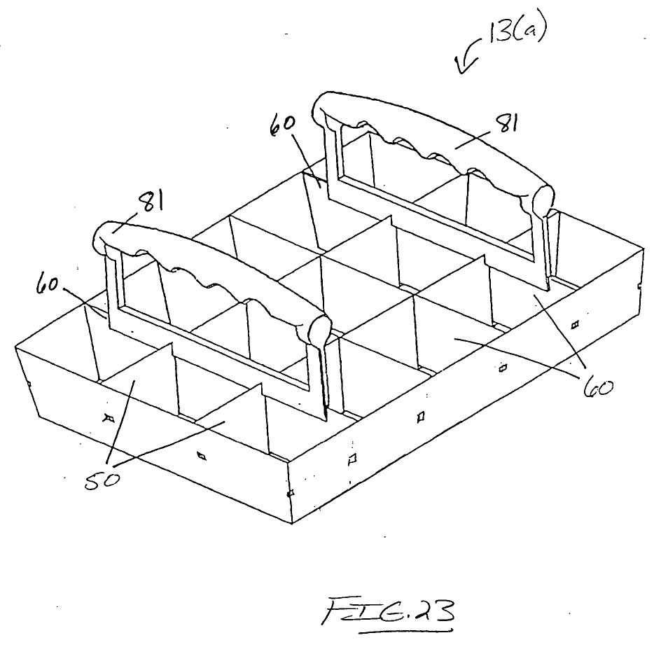

The blade assembly 13 preferably comprises at least one, but preferably two or more, substantially planar, lateral cutting blade(s) 50 as illustrated and referenced in FIGS. 1, 2, 4-7, 9, 10, 14, 20, and 22-23; at least one, but preferably two or more, substantially planar, longitudinal cutting blade(s) 60 as illustrated and referenced in FIGS. 1, 2, 4-7, 9, 10, 14, 20, and 22-23; and at least one force-imparting handle 80 as illustrated and referenced in FIGS. 1, 2, 4, 6, 7, 9-12, and 14. An alternative force-imparting handle 81 is illustrated and referenced in FIGS. 18-20, 22, and 23 thereby rendering an alternative blade assembly 13(a) as further referenced in the noted figures.

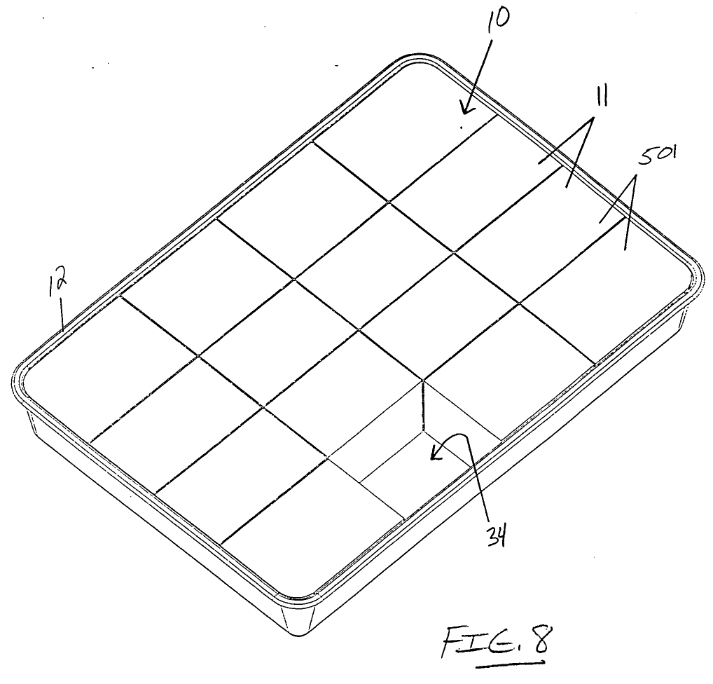

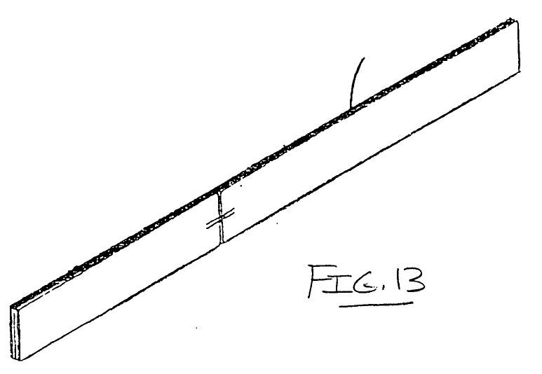

The lateral and longitudinal cutting blades 50 and 60 are preferably hingedly joined for enabling a user to vary blade angles, the variable blade angles extending intermediate the lateral and longitudinal cutting blades and variable intermediate 0° and 180° for collapsing blade assembly 13 for storage as generally depicted in FIG. 13 (shown with handle 80 removed) and re-expanding or reopening the blade assembly 13 for cutting as generally and comparatively depicted in FIG. 9 (showing the blade assembly 13 in a partially collapsed/expanded state) versus FIG. 10 (showing the blade assembly 13 in a fully expanded-cutting state).

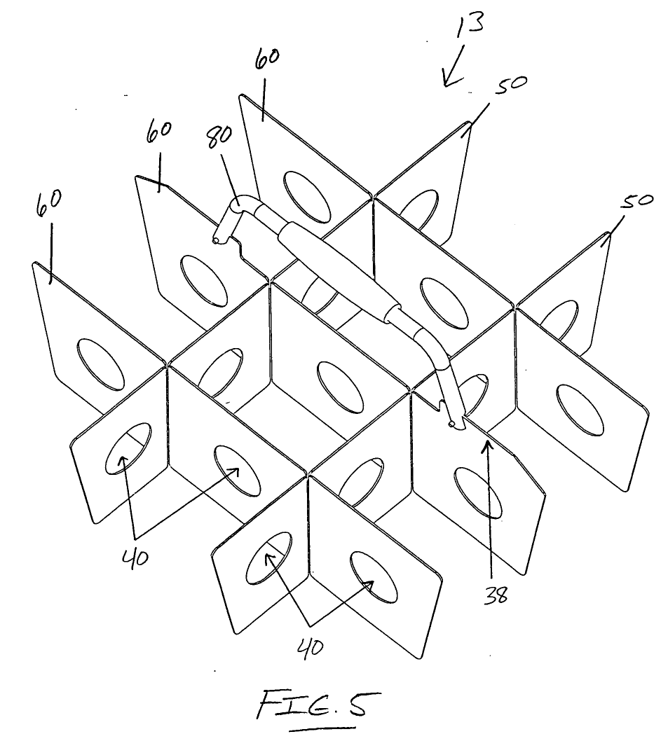

It is further contemplated that the blade assembly 13 may preferably comprise two laterally-spaced, force-imparting handles 80 as generally depicted in FIGS. 6, 7, 9, and 10. When two laterally-spaced force-imparting handles 80 are incorporated into the design, the same are and longitudinally displaceable (in opposing directions as depicted at vector arrows 18) for varying the blade angles intermediate an angle range of about 0 degrees to about 180 degrees. FIG. 10, for example, depicts the blade angles at about 90 degrees—90 degrees (fully expanded); FIG. 9 depicts the blade angles at about 45 degrees—135 degrees (partially collapsed/expanded); and FIG. 13 depicts the blade angles at about 0 degrees—180 degrees (fully collapsed). The force-imparting handles 80 thus function to enable or enhance the user's ability to reversibly configure the cutting blade configuration intermediate a stowing, collapsed blade state and a food-sectioning, grid-like state.

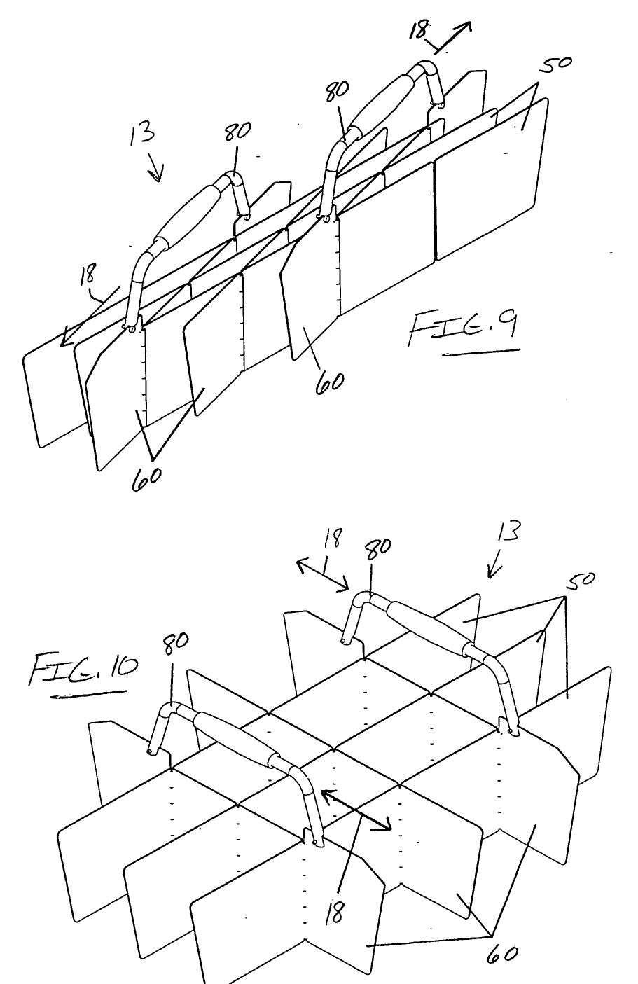

It is contemplated that piano hinge type connections 19, as referenced in FIGS. 11-12, and 22, function to pivotally connect the cutting blades 50 and 60. The piano hinge type connections 19 may be preferably defined by pin-receiving structure(s) 20 and a pin 21 receivable in the pin-receiving structure(s) 20 as illustrated and referenced in FIG. 11(a). The piano hinge type connections 19 may thus effectively function to hingedly connect the cutting blades 50 and 60, thereby providing certain means for pivotally changing the relationship between the cutting blades from the criss-cross, food-sectioning, grid-like arrangement to a substantially coplanar or collapsed blade state or arrangement for storage.

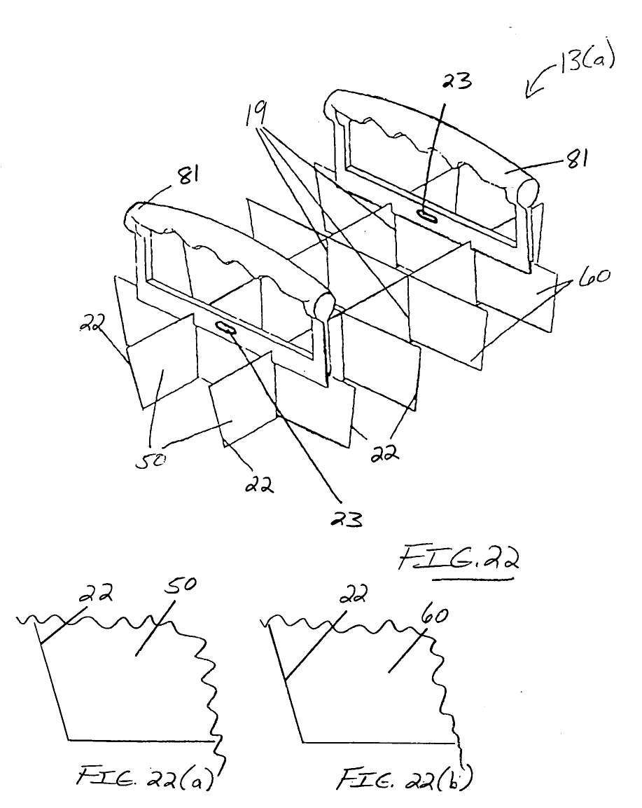

Each lateral cutting blade 50 is designed to laterally and vertically section the food preparation 10 from the food surface 501 to the food bottom 500 intermediate the longitudinal food portions 503 and substantially parallel to the latitudinal food portions 502 at the food bottom 500. The blades 50 and 60 each preferably comprise angled ends 22 as illustrated and referenced in FIGS. 22-22(b) to completely cut through the food bulk. Similarly, the longitudinal cutting blade longitudinally and vertically sections the food preparation 10 from the food surface 501 to the food bottom 500 intermediate the latitudinal food portions 502 and substantially parallel to the longitudinal food portions 503 at the food bottom 500.

Further, the lateral and longitudinal cutting blades 50 and 60 each preferably comprise a minimal blade depth 101 and a maximal blade depth 102 as referenced in FIG. 25. It will be seen from an inspection of the figure that the minimal blade depth 101 is preferably greater in magnitude than the maximal bulk thickness 100 for exposing at least one superior blade junction 55 in superior adjacency to the food surface 501, which blade junctions 55 are further referenced in FIG. 2. The maximal blade depth 102, optionally pronounced as at 38 in FIGS. 5, 6, and 25, together with the upwardly extending rigid handle structure 30 of the force-imparting handle 80 are cooperable for preventing manual food contact (i.e. contact intermediate one's insertable hand as at 39 in FIG. 25 and the food surface 501) when the user manually imparts vertically directed forces to the blade assembly 13.

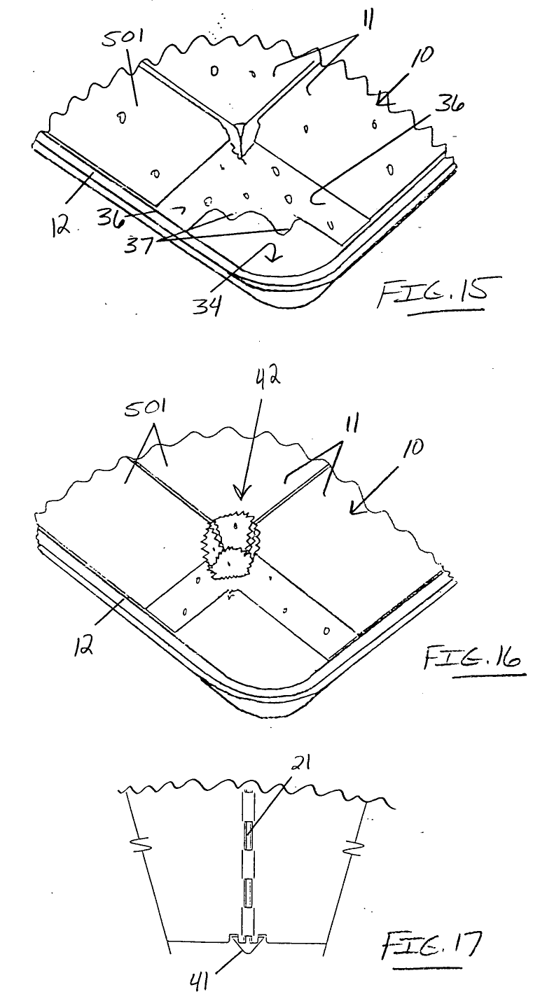

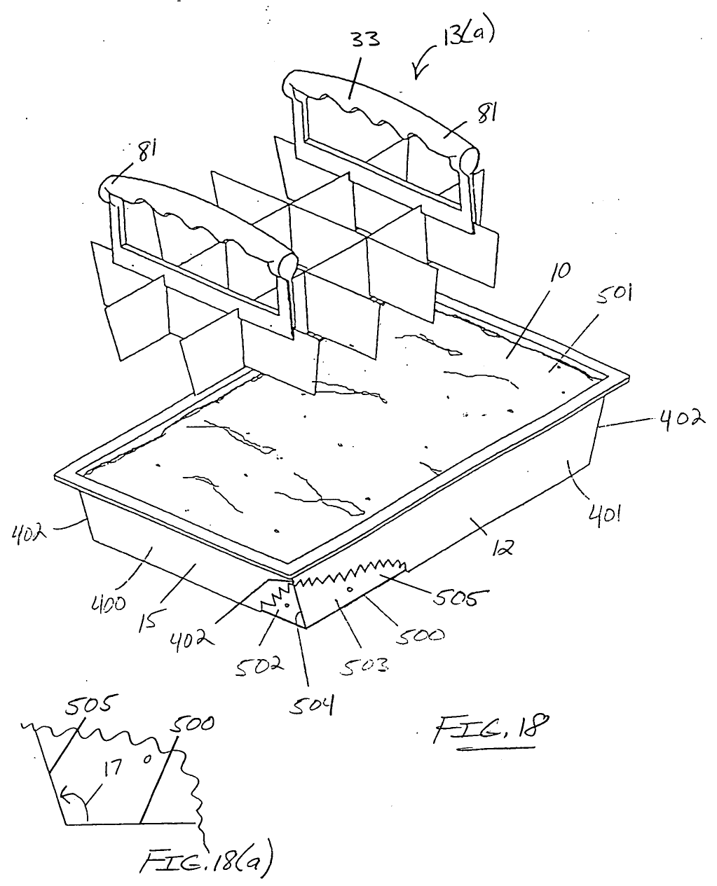

In inferior relation to the superior blade junction, it is contemplated that the blade assemblies 13 or 13(a) may optionally comprise certain pointed structure 41 as illustrated and referenced in FIG. 17. In other words, it is contemplated that each pin 21 may preferably comprise a pointed tip or pointed structure 41 at the inferior end thereof. In this regard, it should be noted that it has been found when blade junctions attempt to section through a food item or food preparation 10, oftentimes the food item region in radial adjacency to the junction becomes smashed as generally depicted in FIG. 16 at reference numeral 42. Since a primary purpose of the present invention is to cleanly section and neatly display sectioned food preparations, unsightly smashed regions at blade junctions are not preferred. To remedy the defect, it has been found that pointed structure 41 functions to provide a cleaner sectioning function which results in a neater food preparation display as generally depicted (for comparative purposes) in FIG. 13 at reference numeral 43. Thus, it is contemplated that the blade junction preferably comprises an inferior junction end, the inferior junction end comprising pointed structure 41 for piercing the bulk food portion at the blade junction and for preventing bulk food portion compaction as at 42 when the food preparation 10 is sectioned into a plurality of food sections 11.

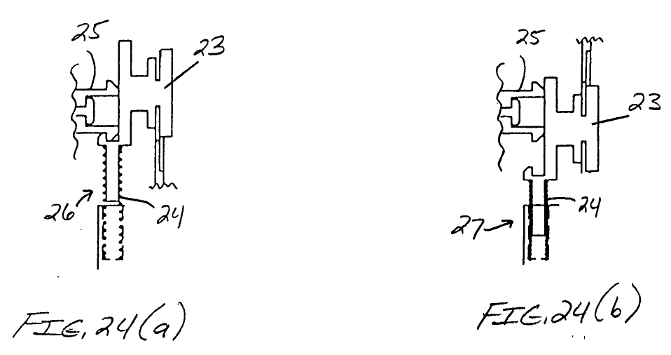

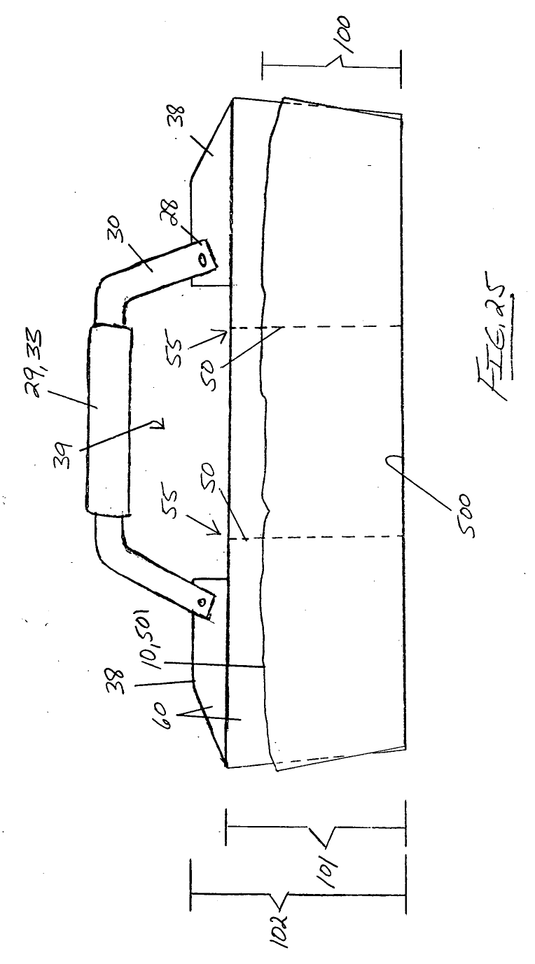

The force-imparting handles 80 or 81 of the present invention may be manually (i.e. via the user's hand) removable, as may be achieved by certain push-button structure 23 that can be manually depressed to release the handles 80 or 81 from the cutting blades 50 or 60, which push-button structure is illustrated and referenced in FIGS. 14(a), 22, 24(a), and 24(b). From an inspection of FIGS. 24(a) and 24(b), it will be seen that push-button structure 23 is cooperably associated with certain spring-actuating means 24 and certain button-retaining means 25. When in a relaxed spring state 26 as generally depicted in FIG. 24(a), push-button structure 23 engages the button-retaining means 25 attached to either a blade 50 or 60 for retaining force-imparting handles 80 or 81 thereto. When manually depressed into an actuated spring state 27 as generally depicted in FIG. 24(b), the push-button structure 23 disengages the button-retaining means 25 for selectively releasing the handle 80 or 81 therefrom.

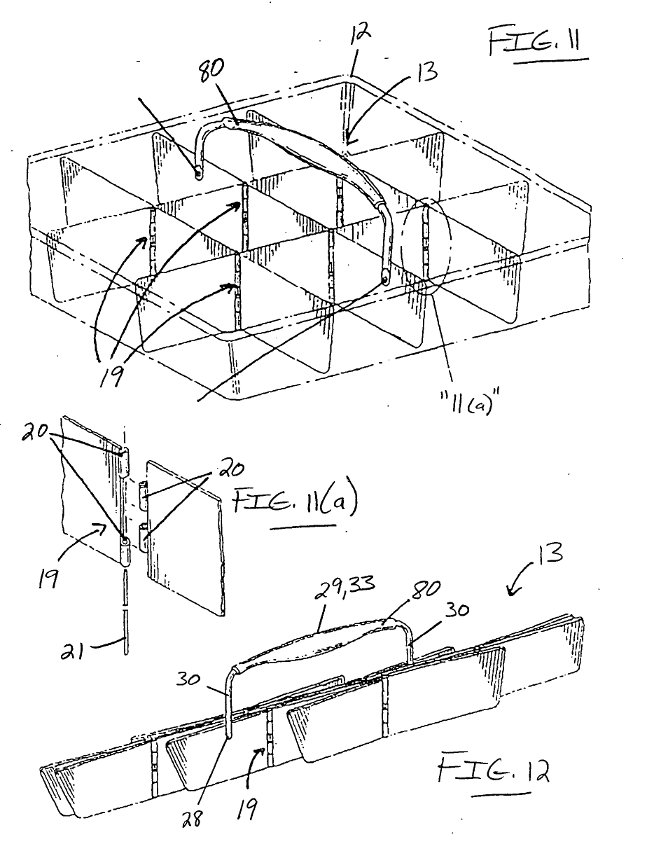

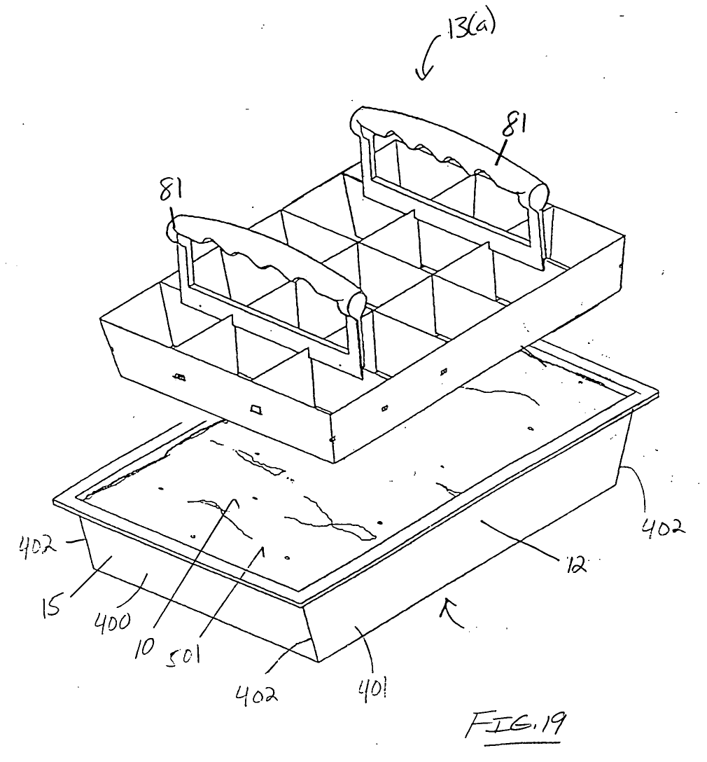

It is contemplated, in any event, that the force-imparting handle 80 or 81 is removable from blades 50 and/or 60 for the purpose of minimizing storage bulk of the blade assembly 13 or 13(a). The force-imparting handle 80 (or 81) preferably comprises a blade-engaging end 28, a hand-engaging end 29, and certain rigid handle structure 30 as generally depicted and referenced in FIG. 12 for enabling effective force transfer from the handle 80 to the cutting blades 50 and 60. In this regard, it will be seen that the rigid handle structure 30 extends intermediate the blade-engaging end 28 and the hand-engaging end 29. The blade-engaging end 28 preferably comprises blade-receiving structure such as a blade-receiving notch(es) 31 or groove(s) as generally depicted and referenced in FIG. 14(a), which figure is a fragmentary generic depiction of the blade-engaging end 28 receiving or coacting with a superior blade end 32. Further, from an inspection of the noted figures, it will be seen that the hand-engaging end 29 preferably comprises a hand-grip portion 33 as specifically referenced in FIGS. 12, 14, 18, and 25. The blade-receiving notches 31 removably receive the superior blade end 32 of the cutting blades 50, 55, and 60 as generally depicted and referenced in FIGS. 18 and 19.

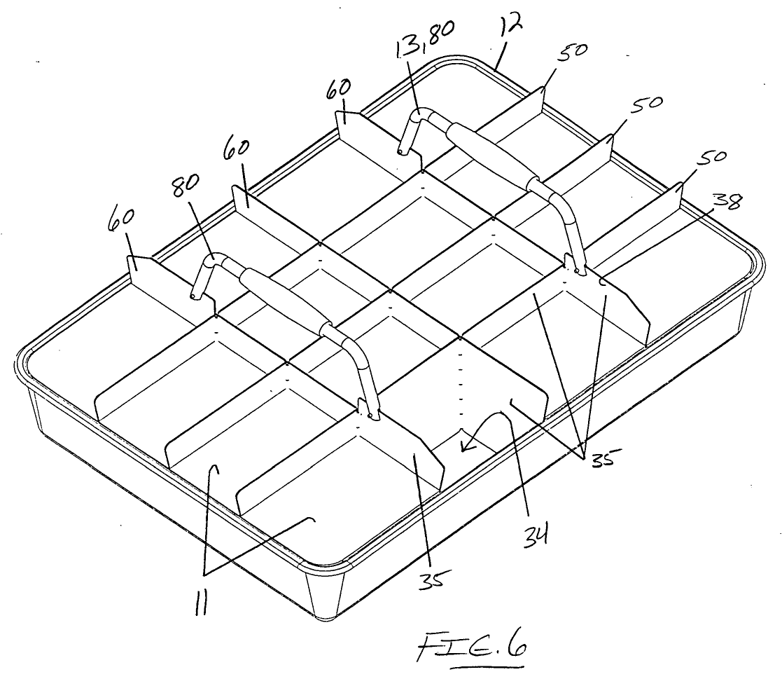

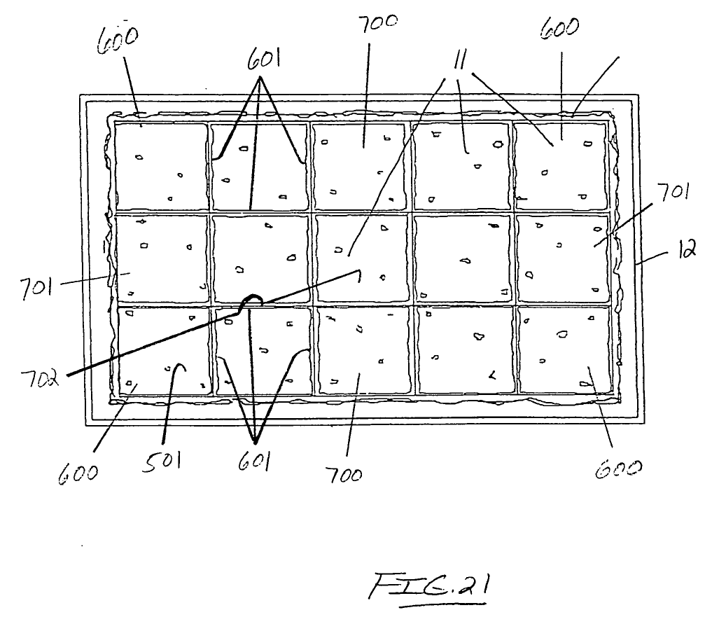

The hand grip portion or hand-engaging end 29 together with the rigid handle structure 30 enable a user to manually impart vertically directed forces to the blade assembly 13. Thereby, the food preparation 10 may be effectively sectioned into a plurality of food sections 11 via the downwardly directed lateral and longitudinal cutting blades 50 and 60. In this regard, it will be seen from an inspection of FIGS. 20 and 21 that the food sections 11 preferably comprise four corner food sections 600 and that each food section 11 comprises at least two vertical, substantially planar (i.e. smooth) adjacent section walls 601 (as referenced in FIG. 21). Notably, each corner food section 600 will comprise two angled, substantially planar adjacent section walls 602 as referenced in FIG. 7. The adjacent section walls 602 preferably extend away from another at substantially right angles as may be gleaned from a comparative inspection of FIG. 7 versus FIG. 21. The downwardly directed lateral and longitudinal cutting blades 50 and 60 prevent adjacent food sections from contacting one another. The food-presentation system of the present invention thus functions to section a container-prepared food preparation 10 in(to) a plurality of food sections 11.

In terms of displaying the container-prepared food preparation 10, it is contemplated that the food presentation system of the present invention may well function to display the otherwise sectioned food preparation 10 to potential consumers. In this regard, the reader is directed to FIGS. 1, 3, 4, 6, 8, 20, and 21, all of which attempt to illustrate how the food preparation 10 may be displayed for potential consumers after sectioning the same into food sections 11. In this regard, it should be noted that blade assembly 13 (or 13(a)) may well function to corral the food sections 11. In other words, the downwardly directed lateral and longitudinal cutting blades 50 and 60 thereby provide planar barriers 35 between the corralled food sections 11 and matter external to the corralled food sections 11 as depicted and referenced in FIGS. 1, 4, 6, and as may be further understood from a general inspection of FIG. 21.

Further, it is contemplated that the food preparation 10 and the blade assembly 13 are preferably cooperably removable from the food preparation container 12, or alternatively, that the food preparation container 12 is removable from the food preparation 10 and the blade assembly 13 as generally depicted in FIG. 4. It will be seen from an inspection of FIG. 4, that the blade assembly 13 (with container 12 removed) thereby enables provision of certain food service stations 44 for enhancing food section 11 removal from the blade assembly 13. In other words, food item or section consumers may obtain certain food sections 11 by removing same in a direction perpendicular to the sectioning movement of handle 80 from those regions where container 12 would otherwise be retaining the food section walls.

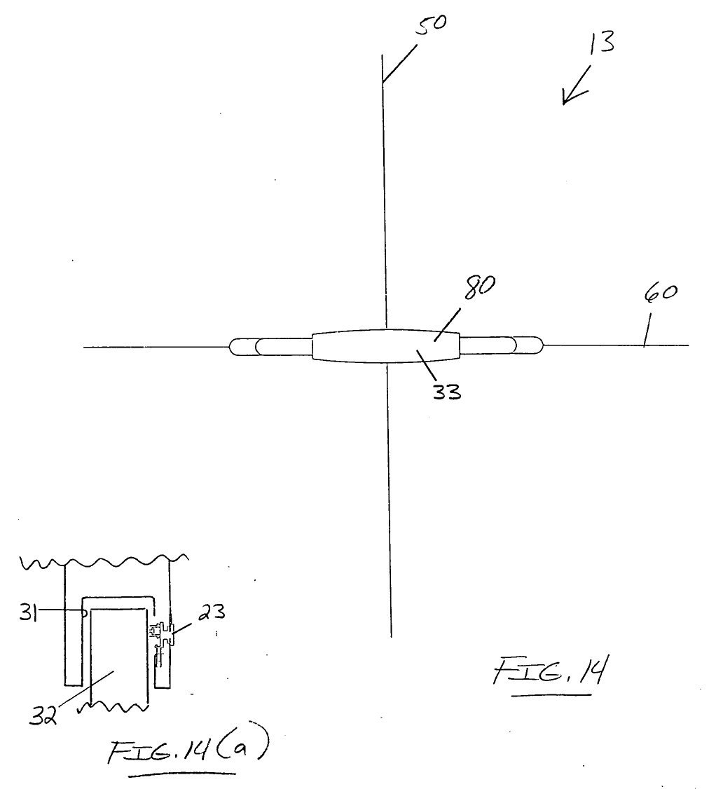

It will be further seen from an inspection of the noted figures that at least one select food section is removable from the food preparation container 12 for creating a section vacancy 34 as generally depicted in FIGS. 1, 3, 4, 6, 8, and 15. The planar barrier(s) 35 may well function to prevent the container-borne bulk food portions 36 from otherwise entering (as at 37) the section vacancy(ies) 34 as is generally depicted in FIG. 15, and further prevent matter from contacting the food section otherwise protected by the barriers 35, as for example, to prevent the food section from drying (i.e. moisture-retention or air-contact prevention) out at its outermost bulk food portion. In this last regard, it is contemplated that the blades 50 and 60 preferably comprise ornamental blade surfaces 45 or other ornamentation for providing at least one ornamentally-bound section vacancy as generally depicted in FIG. 1.

In this last regard, it is contemplated that the blades 50 and 60 may be preferably constructed from stainless steel or similar other material having a highly reflective, polished surface for effecting a certain degree of ornamentation adjacent the section vacancy. Further, it is contemplated that the lateral and longitudinal cutting blades 50 and 60 may optionally comprise blade apertures 40 as illustrated and referenced in FIG. 5. It is contemplated that the optional blade apertures 40 may well function not only to provide a certain degree of ornamentation, but also provide the manufacturer with reduced material(s) cost. Further, certain food items may benefit from exposure to adjacent materials as enabled via the blade apertures 40. For example, with certain baked goods, the blade apertures function to prevent sticking of the blade as it sections the food item. It is thus contemplated that the blade apertures 40 extend intermediate the opposing ornamental surfaces for facilitating food preparation sectioning and for providing at least one apertured, ornamentally-bound section vacancy 34. Further, it is contemplated that the food presentation system of the present invention may well function to section the container-borne food preparation 10 and effectively display a substantial portion thereof.

While the above description contains much specificity, this specificity should not be construed as limitations on the scope of the invention, but rather as an exemplification of the invention. For example, the invention may be said to essentially disclose a blade assembly for sectioning and displaying a food preparation as prepared in a food preparation container. The blade assembly of the present invention may be said to essentially comprise at least one substantially planar, lateral cutting blade, at least one substantially planar, longitudinal cutting blade, and at least one force-imparting handle as generally depicted in FIG. 14. The lateral and longitudinal cutting blades may comprise opposing ornamental blade surfaces and may be hingedly joined for enabling a user to selectively vary blade angles extending intermediate the lateral and longitudinal cutting blades.

The lateral cutting blade function to laterally and vertically section a food preparation from its food surface to the food bottom intermediate the longitudinal food portions. Similarly, the longitudinal cutting blade functions to longitudinally and vertically section the food preparation from the food surface to the food bottom intermediate the latitudinal food portions. The force-imparting handle comprises a blade-engaging end, a hand-engaging end, and rigid handle structure extending intermediate the blade-engaging end and the hand-engaging end. The blade-engaging end comprises certain blade attachment means and the hand-engaging end may comprise a hand-grip portion. The blade attachment means removably attach the handle to a select cutting blade, the select cutting blade being selected from the group consisting of the lateral cutting blade and the longitudinal cutting blade.

The hand grip portion and the rigid handle structure enabling a user to manually impart vertically directed forces to the blade assembly. The food preparation may be thereby sectioned into a plurality of food sections via the downwardly directed lateral and longitudinal cutting blades. The lateral and longitudinal cutting blades further function to corral the resulting food sections, comprising at least four corner food sections, and each food section comprising at least two vertical, substantially planar adjacent section walls and two angled, substantially planar adjacent section walls. The adjacent section walls extend away from one another at substantially right angles.

As stated, the downwardly directed lateral and longitudinal cutting blades thereby provide a planar barrier between the corralled food sections and matter external to the corralled food sections. Notably, at least one select food section is removable from the food preparation container for creating a section vacancy. In this regard, it is noted that the planar barrier may further function to prevent the container-borne bulk food portions from entering the section vacancy. Further, the ornamental blade surfaces may function to provide at least one ornamentally-bound section vacancy. Thus, it is contemplated that the blade assembly of the present invention enables a food presentation system for sectioning a container-borne food preparation and uniquely displaying a substantial portion thereof.

Further, the foundational elements of the invention may thus be said to teach or disclose a foldable food cutter for sectioning an entire food item within a food preparation container into a plurality of equally sized smaller sections, the cutter comprising at least one lateral cutting blade, at least one longitudinal cutting blade, and at least one (removable) handle. The lateral cutting blade laterally sections an entire food item width within a food preparation container during use with at least one engaging hinge portion. The longitudinal cutting blade longitudinally sections an entire food item length within a food preparation container with at least one retaining hinge portion hingedly connected to the engaging hinge portion of the lateral cutting blade providing pivotal freedom of movement between the lateral cutting blade and the longitudinal cutting blade, the lateral cutting blade and the longitudinal cutting blade coacting to cut at least two sides of a food item section during use. The handle is shaped for providing manual force perpendicular to the lateral cutting blade and longitudinal cutting blade during use.

Stated another way, the foldable cutter of the present invention may be said to section an entire food item within a food preparation container into a plurality of equally smaller sections. To achieve this function, the cutter comprises an orthogonally arranged lattice of cutting blades sized and shaped to fit within a food preparation container having an upright side. The cutting blades may thus section an entire food item within the food preparation container into a plurality of smaller sections. A plurality of hinge connections hingedly connect the cutting blades providing means for pivotally changing the relationship between the cutting blades from the orthogonal arrangement to a substantially coplanar arrangement. Further, at least one handle enables provision of manual force perpendicular to the cutting blades during use.

Accordingly, although the invention has been described by reference to a number of preferred and alternative embodiments, it is not intended that the novel system, device or assembly be limited thereby, but that modifications thereof are intended to be included as falling within the broad scope and spirit of the foregoing disclosure, the following claims and the appended drawings.

We claim:

1. A food-presentation system, the food-presentation system for sectioning and displaying a container-prepared food preparation in a plurality of food sections, the food-presentation system comprising, in combination:
a food preparation container, the food preparation container comprising a rectangular, substantially planar container bottom and a peripheral container wall, the container wall being integrally formed to the container bottom extending upwardly and outwardly therefrom at a container angle of inclination, the container angle of inclination being greater 90 degrees for enabling angled food access via the container wall, the angled food access for enhancing food removal, the container wall comprising first and second substantially planar latitudinal container portions and first and second substantially planar longitudinal container portions, the latitudinal and longitudinal container portions being joined at four container corners;
a container-borne food preparation, the food preparation being form-prepared in the food preparation container, the food preparation comprising a substantially planar food bottom, a peripheral food wall, a superior food surface, and a blade-sliceable bulk food portion, the bulk food portion being bound by the food bottom, food wall, and food surface, the food wall extending upwardly and outwardly from the food bottom at a food angle of inclination, the food angle of inclination being equal in magnitude to the container angle of inclination, the food wall comprising first and second substantially planar latitudinal food portions and first and second substantially planar longitudinal food portions, the latitudinal and longitudinal food portions each being joined at four food corners; and
a blade assembly, the blade assembly comprising at least one substantially planar, lateral cutting blade, at least one substantially planar, longitudinal cutting blade, and at least one force-imparting handle, the lateral and longitudinal cutting blades comprising opposing ornamental blade surfaces and being hingedly joined for enabling a user to selectively vary blade angles, the variable blade angles extending intermediate the lateral and longitudinal cutting blades, the lateral cutting blade for laterally and vertically sectioning the food preparation from the food surface to the food bottom intermediate the longitudinal food portions and substantially parallel to the latitudinal food portions at the food bottom, the longitudinal cutting blade for longitudinally and vertically sectioning the food preparation from the food surface to the food bottom intermediate the latitudinal food portions and substantially parallel to the longitudinal food portions at the food bottom, the force-imparting handle comprising a blade-engaging end, a hand-engaging end, and rigid handle structure, the rigid handle structure extending intermediate the blade-engaging end and the hand-engaging end, the blade-engaging end comprising blade attachment means, the hand-engaging end comprising a hand-grip portion, the blade attachment means removably attaching the force-imparting handle to a select cutting blade, the select cutting blade being selected from the group consisting of the lateral cutting blade and the longitudinal cutting blade, the hand grip portion and the rigid handle structure enabling a user to manually impart vertically directed forces to the blade assembly, the food preparation being sectioned into a plurality of food sections via the downwardly directed lateral and longitudinal cutting blades, the lateral and longitudinal cutting blades thus corralling the food sections, the food sections comprising four corner food sections, each food section comprising at least two vertical, substantially planar adjacent section walls, each corner food section comprising two angled, substantially planar adjacent section walls, the adjacent section walls extending away from another at substantially right angles, the downwardly directed lateral and longitudinal cutting blades thereby providing planar barriers between the corralled food sections and matter external to the corralled food sections, at least one select food section being removable from the food preparation container for creating a section vacancy, the planar barriers for preventing the bulk food portions from entering the section vacancy, the ornamental blade surfaces for providing at least one ornamentally-bound section vacancy, the food presentation system thus sectioning the food preparation and displaying a portion thereof.

2. The food-presentation system of claim 1 wherein the bulk food portion has a maximal bulk thickness, the maximal bulk thickness extending intermediate the food bottom and food surface, the lateral and longitudinal cutting blades each having a minimal blade depth, the minimal blade depth being greater in magnitude than the maximal bulk thickness for exposing at least one superior blade junction in superior adjacency to the food surface.

3. The food-presentation system of claim 1 wherein the select cutting blade has a maximal blade depth, the maximal blade depth and the rigid handle structure being cooperable for preventing manual food contact when the user manually imparts vertically directed forces to the blade assembly.

4. The food-presentation system of claim 1 wherein the lateral and longitudinal cutting blades comprise blade apertures, the blade apertures extending intermediate the opposing ornamental surfaces, the blade apertures for facilitating food preparation sectioning and for providing at least one apertured, ornamentally-bound section vacancy.

5. The food-presentation system of claim 1 comprising two laterally-spaced, force-imparting handles attachable to two select cutting blades, the force-imparting handles being cooperable and longitudinally displaceable for varying the blade angles intermediate an angle range of about 0 degrees to about 180 degrees, the force-imparting handles for enabling the user to reversibly configure the cutting blade configuration intermediate a stowing, collapsed blade state and a food-sectioning, grid-like state.

6. The food-presentation system of claim 1 wherein each hingedly joined lateral and longitudinal cutting blade forms a blade junction, the blade junction having an inferior junction end, the inferior junction end comprising pointed structure, the pointed structure for piercing the bulk food portion at the blade junction and for preventing bulk food portion compaction when the food preparation is sectioned into a plurality of food sections.

7. The food-presentation system of claim 1 wherein the food preparation and the blade assembly are cooperably removable from the food preparation container, the blade assembly thereby providing food service stations for enhancing food section removal from the blade assembly.

8. A food-presentation system for sectioning and displaying a container-prepared food preparation in a plurality of food sections, the food-presentation system comprising, in combination:
a food preparation container, the food preparation container comprising a substantially planar container bottom and a peripheral container wall, the container wall being integrally formed to the container bottom extending upwardly therefrom, the container wall comprising first and second substantially planar latitudinal container portions and first and second substantially planar longitudinal container portions, the latitudinal and longitudinal container portions being joined at four container corners;
a container-borne food preparation, the food preparation being form-prepared in the food preparation container, the food preparation thus comprising a substantially planar food bottom, a peripheral food wall, a superior food surface, and a blade-sliceable bulk food portion, the bulk food portion being bound by the food bottom, food wall, and food surface, the food wall extending upwardly from the food bottom, the food wall comprising first and second substantially planar latitudinal food portions and first and second substantially planar longitudinal food portions, the latitudinal and longitudinal food portions each being joined at four food corners; and
a blade assembly, the blade assembly comprising at least one substantially planar, lateral cutting blade, at least one substantially planar, longitudinal cutting blade, and at least one force-imparting handle, the lateral and longitudinal cutting blades comprising opposing blade surfaces and being pivotally joined for enabling a user to vary blade angles, the variable blade angles extending intermediate the lateral and longitudinal cutting blades, the lateral cutting blade for laterally and vertically sectioning the food preparation from the food surface to the food bottom intermediate the longitudinal food portions and substantially parallel to the latitudinal food portions at the food bottom, the longitudinal cutting blade for longitudinally and vertically sectioning the food preparation from the food surface to the food bottom intermediate the latitudinal food portions and substantially parallel to the longitudinal food portions at the food bottom, the force-imparting handle comprising a blade-engaging end, a hand-engaging end, and rigid handle structure, the rigid handle structure extending intermediate the blade-engaging end and the hand-engaging end, the blade-engaging end being cooperatively associated with at least one select cutting blade, the select cutting blade being selected from the group consisting of the lateral cutting blade and the longitudinal cutting blade, the hand-engaging end and the rigid handle structure enabling a user to manually impart vertically directed forces to the blade assembly, the food preparation being sectioned into a plurality of food sections via the downwardly directed lateral and longitudinal cutting blades, the food sections comprising at least two vertical, substantially planar adjacent section walls, the adjacent section walls extending away from another at substantially right angles, the downwardly directed lateral and longitudinal cutting blades thereby providing planar barriers between the food sections and matter external to the food sections, at least one select food section being removable from the food preparation container for creating a section vacancy, the planar barriers for preventing the container-borne bulk food portions from entering the section vacancy, the opposing blade surfaces for providing at least one blade-bound section vacancy, the food presentation system thus sectioning the container-borne food preparation and displaying a portion thereof.

9. The food-presentation system of claim 8 wherein the bulk food portion has a maximal bulk thickness, the maximal bulk thickness extending intermediate the food bottom and food surface, the lateral and longitudinal cutting blades each having a minimal blade depth, the minimal blade depth being greater in magnitude than the maximal bulk thickness for exposing at least one superior blade junction in superior adjacency to the food surface.

10. The food presentation system of claim 8 wherein the select cutting blade has a maximal blade depth, the maximal blade depth and the rigid handle structure being cooperable for preventing manual food contact when the user manually imparts vertically directed forces to the blade assembly.

11. The food-presentation system of claim 8 wherein the lateral and longitudinal cutting blades comprise blade apertures, the blade apertures extending intermediate the opposing ornamental surfaces, the blade apertures for facilitating food preparation sectioning and for providing at least one apertured, blade-bound section vacancy.

12. The food-presentation system of claim 8 wherein each pivotally joined lateral and longitudinal cutting blade forms a blade junction, the blade junction having an inferior junction end, the inferior junction end comprising pointed structure, the pointed structure for piercing the bulk food portion at the blade junction and for preventing bulk food portion compaction when the food preparation is sectioned into a plurality of food sections.

13. The food-presentation system of claim 8 wherein the food preparation and the blade assembly are cooperably removable from the food preparation container, the blade assembly thereby providing food service stations for enhancing food section removal from the blade assembly.

14. A food-presentation system for sectioning and displaying a container-prepared food preparation in a plurality of food sections, the food-presentation system comprising, in combination:
a food preparation container, the food preparation container comprising a substantially planar container bottom and a peripheral container wall, the container wall being integrally formed to the container bottom extending upwardly therefrom;
a food preparation, the food preparation being form-prepared in the food preparation container, the food preparation comprising a substantially planar food bottom, a peripheral food wall, a superior food surface, and a blade-sliceable bulk food portion, the bulk food portion being bound by the food bottom, food wall, and food surface, the food wall extending upwardly from the food bottom; and
a blade assembly, the blade assembly comprising at least one substantially planar, lateral cutting blade, at least one substantially planar, longitudinal cutting blade, and at least one force-imparting handle, the lateral and longitudinal cutting blades comprising opposing blade surfaces and being pivotally joined for enabling a user to vary blade angles, the variable blade angles extending intermediate the lateral and longitudinal cutting blades, the lateral cutting blade for laterally and vertically sectioning the food preparation from the food surface to the food bottom intermediate laterally opposed portions thereof, the longitudinal cutting blade for longitudinally and vertically sectioning the food preparation from the food surface to the food bottom intermediate longitudinal portions thereof, the force-imparting handle comprising a blade-engaging end and a hand-engaging end, the blade-engaging end being cooperatively associated with at least one select cutting blade, the select cutting blade being selected from the group consisting of the lateral cutting blade and the longitudinal cutting blade, the hand-engaging end enabling a user to impart vertically directed forces to the blade assembly, the food preparation being sectioned into a plurality of food sections via the downwardly directed lateral and longitudinal cutting blades, the food sections comprising at least two vertical, substantially planar adjacent section walls, the adjacent section walls extending away from another at substantially right angles, the downwardly directed lateral and longitudinal cutting blades thereby providing planar barriers between the food sections and matter external to the food sections, at least one select food section being removable from the food preparation container for creating a section vacancy, the planar barriers for preventing the container-borne bulk food portions from entering the section vacancy, the opposing blade surfaces for providing at least one blade-bound section vacancy, the food presentation system thus sectioning the food preparation and displaying a portion thereof.

15. The food-presentation system of claim 14 wherein the food preparation and the blade assembly are cooperably removable from the food preparation container, the blade assembly thereby providing food service stations for enhancing food section removal from the blade assembly.

16. The food-presentation system of claim 14 wherein the bulk food portion has a maximal bulk thickness, the maximal bulk thickness extending intermediate the food bottom and food surface, the lateral and longitudinal cutting blades each having a minimal blade depth, the minimal blade depth being greater in magnitude than the maximal bulk thickness for exposing at least one superior blade junction in superior adjacency to the food surface.

17. The food presentation system of claim 14 wherein the select cutting blade has a maximal blade depth, the maximal blade depth and the force-imparting handle being cooperable for preventing manual food contact when the user manually imparts vertically directed forces to the blade assembly.

18. The food-presentation system of claim 14 wherein the lateral and longitudinal cutting blades comprise blade apertures, the blade apertures extending intermediate the opposing blade surfaces, the blade apertures for facilitating food preparation sectioning and for providing at least one apertured, blade-bound section vacancy.

19. The food-cutting system of claim 14 comprising two laterally-spaced, force-imparting handles attachable to two select cutting blades, the force-imparting handles being cooperable and longitudinally displacable for varying the blade angles intermediate an angle range of about 0 degrees to about 180 degrees, the force-imparting handles for enabling the user to reversibly configure the cutting blade configuration intermediate a stowage, collapsed blade state and a food-sectioning, grid-like state.

20. The food-presentation system of claim 14 wherein pivotally joined lateral and longitudinal cutting blade forms a blade junction, the blade junction having an inferior junction end, the inferior junction end comprising pointed structure, the pointed structure for piercing the bulk food portion at the blade junction and for preventing bulk food portion compaction when the food preparation is sectioned into the plurality of food sections.
